(19) United States
(12) Patent Application Publication
(10) Pub. No.: US 2026/0270078 A1
(43) Pub. Date: Sep. 10, 2026

(54) STORING OF DATA IN A LEDGER FOR DATA-DRIVEN REAL-TIME APPLICATIONS

(71) Applicant: TRAENT S.R.L., Milano (IT)

(72) Inventors: Claudio Felicioli, Via Giuseppe Cesare Abba 4, PISA (IT); Andrea Canciani, Via delle Medaglie d'oro 13, PISA (IT); Fabio Severino, Piazza Cairoli 3, PISA (IT)

(73) Assignee: TRAENT S.R.L., Milano (IT)

(21) Appl. No.: 18/869,383

(22) PCT Filed: May 29, 2023
(86) PCT No.: PCT/EP2023/064314

§ 371 Date: Nov. 26, 2024

(30) Foreign Application Priority Data
May 30, 2022 (IT) 102022000011369

(51) Int. Cl. H04L 9/32

(52) U.S. Cl. CPC H04L 9/3247

(57) ABSTRACT

A solution is proposed for storing data. The solution comprises storing (410,415) a sequence of data blocks (BLKᵢ) in at least one first repository means (110D) of a ledger (110). The solution comprises computing (420), for each data block of the sequence of data blocks, a block hash (BHᵢ) being a hash value of said data block. The solution comprises computing (425), for each data block of the sequence of data blocks, a link hash (LHᵢ) being a hash value based on the block hash of said data block and on the link hash of a previous data block, in the sequence of data blocks, being adjacent to said data block. The solution comprises determining (435,440) history information (Hⱼ) associated with each set of one or more adjacent data blocks of said sequence of data blocks based on the link hashes of the data blocks of said set of adjacent data blocks. The solution comprises storing (445) the history information associated with the sequence of data blocks in a second repository means (110H) of the ledger separate from the at least one first repository means.

### TECHNICAL FIELD

The present disclosure relates to the information technology field. Particularly, this disclosure relates to the storing of data. More particularly, the present disclosure relates to distributed ledger technology.

### BACKGROUND

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

Storing of data is a commonplace activity in most computing systems (for example, for their preservation, outputting, and/or further processing). In several situations, the storing of data is subject to specific requirements.

Particularly, it may be required that the storing of the data is persistent; this means that it should not be possible to remove the data once they have been stored; therefore, any updates of the data should preserve all previous versions of the same data. For this purpose, it may be important to ensure integrity of the data being stored.

Distributed ledger technology (DLT) is a technology used to maintain a distributed ledger, i.e. a replicated, shared, and synchronized collection of digital records spread across multiple computer nodes (also referred to as “participant nodes” or simply “nodes”) typically located across multiple sites, countries, or institutions.

Unlike a traditional database, a conventional distributed ledger has no central data store or administration functionality.

Particularly, a conventional distributed ledger eliminates the need for a single central authority to maintain the integrity of the data stored in the ledger: instead, this task becomes the responsibility of the participant nodes, based on a proper consensus schema.

All information in the ledger typically uses cryptography techniques to ensure consistency, integrity, security and permissions using cryptographic keys, encryption and digital signatures. Once data is committed and stored in the ledger it is considered as an immutable entry in the database of records which is governed by the rules of the consensus schema.

A conventional distributed ledger stores data into a sequence of data blocks in chronological order, linked to each other via corresponding hash values. The ledger is distributed throughout the participant nodes, which validate its content according to the consensus schema. In a consensus schema based on a proof of work, a complex mathematical problem has to be solved by determining a nonce to be added to each data block that provides a specific property of its hash value. Therefore, no data block may be altered without re-determining the nonces of such data block and of all the next data blocks in the ledger; however, the difficulty of the mathematical problem required to determine the nonces makes substantially impossible to alter the distributed ledger (unless a majority of the processing power of the whole network is acquired).

Distributed ledger technology has been initially designed to work with financial data, and the typical data block design is essentially a container for a list of small financial transactions.

More recently, distributed ledger technology is used in fields different than financial field (such as the internet of things, supply chains of various commodities, sharing of secure data, and logistic monitoring), and has great potential to revolutionize the way organizations operate in many industry verticals.

While distributed ledger technology has great potential, the incumbent distributed ledger architectures suffer from some technical problems and limitations. Indeed, even if the requirements for the more recent use-cases are different than the financial original one, distributed ledger technology is still organized to stored data in small transactions.

Particularly, distributed ledger technology provides limited support for generic data other than data associated with small financial transactions. This is a technical limitation for data-driven application use cases.

Moreover, typical distributed ledger technology performance scales poorly as the data that must be stored increases. Indeed, being vertical in nature, all participant nodes need to receive a copy of all (past, present and future) data blocks. Just as a practical example, the size of a Bitcoin block is 1 MB, and is sufficient to process 3-5 transactions per second without issues. However, as the data block size increases to facilitate higher transactional throughput, such as in real-time applications, the propagation time of a data block to all participant nodes in the network also increases. If this propagation time is longer than the interval during which data blocks are created, participant nodes do not receive the latest data blocks in a timely manner and so create new data blocks based on old knowledge. The network becomes saturated with data blocks that are competing with each other and network throughput drops drastically.

### SUMMARY

A simplified summary of the present disclosure is herein presented in order to provide a basic understanding thereof; however, the sole purpose of this summary is to introduce some concepts of the disclosure in a simplified form as a prelude to its following more detailed description, and it is not to be interpreted as an identification of its key elements nor as a delineation of its scope.

In general terms, the present disclosure is based on the idea of storing data blocks in a first repository means and history information associated with the data blocks in second repository means being separate from the first repository means.

Particularly, an aspect provides a method comprising storing a sequence of data blocks in a first repository means of a ledger, computing, for each data block, a block hash and a link hash, wherein the link hash is based on the block hash of the data block and on the link hash of a previous data block, determining history information based on the link hashes of the data blocks of the sequence of data blocks, and storing the history information in a second repository means of the ledger separate from the first repository means.

Another aspect provides a software program (or computer program) for implementing the method.

A further aspect provides a corresponding software program product (or computer program product).

A further aspect provides a computing system for implementing the method.

A further aspect provides a system comprising one or more of said computing systems.

More specifically, one or more aspects of the present disclosure are set out in the independent claims and advantageous features thereof are set out in the dependent claims, with the wording of all the claims that is herein incorporated verbatim by reference (with any advantageous feature provided with reference to any specific aspect that applies mutatis mutandis to every other aspect).

### BRIEF DESCRIPTION OF THE DRAWINGS

The solution according to embodiments of the present disclosure, as well as further features and the advantages thereof, will be best understood with reference to the following detailed description thereof, given purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes, like value, content and representation). Particularly:

FIG. 1A and FIG. 1B show the general principles of the solution according to embodiments of the present disclosure;

FIG. 2 shows a schematic block diagram of an information technology infrastructure that may be used to implement the solution according to embodiments of the present disclosure;

FIG. 3 shows the main software components that may be used to implement the solution according to embodiments of the present disclosure, and

FIG. 4 shows an activity diagram describing the flow of activities relating to an implementation of the solution according to embodiments of the present disclosure.

### DETAILED DESCRIPTION

In the following, when one or more features are introduced by the wording “according to an embodiment”, they are to be construed as features additional or alternative to any features previously introduced, unless otherwise indicated and/or unless there is evident incompatibility among feature combinations.

In the following, only relevant features that are deemed pertinent for the understanding of the present disclosure will be discussed, with well-known and/or obvious variants of the relevant features that will be omitted for the sake of conciseness.

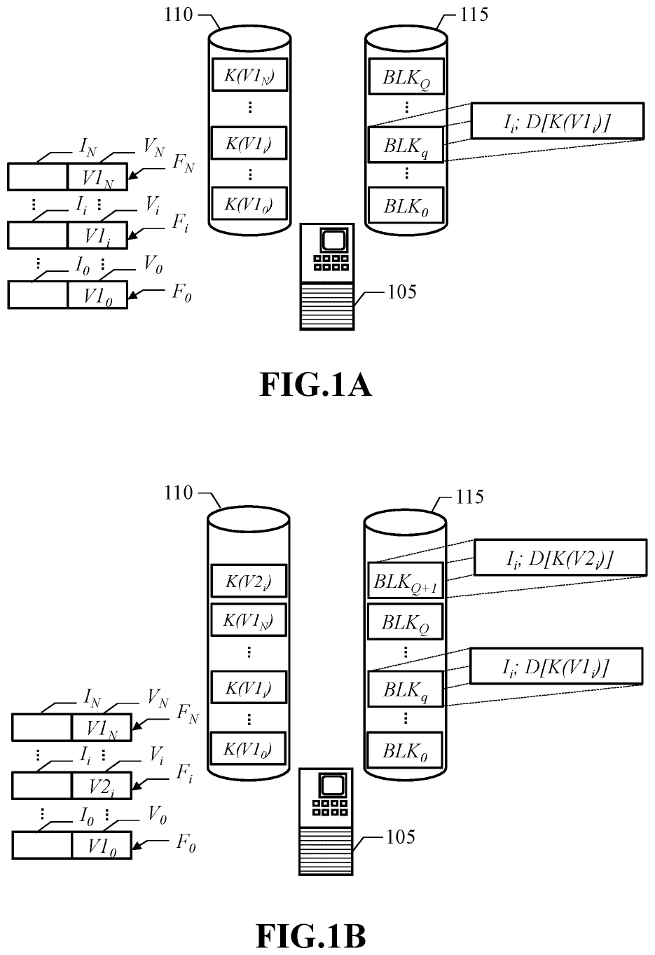

With reference to FIG. 1A and FIG. 1B, they show the general principles of the solution according to embodiments of the present disclosure.

Starting from FIG. 1A, one or more storage nodes 105 (only one shown in the figure) store data. The data are stored into one or more data structures, or simply ledgers 110 (only one shown in the figure).

According to an embodiment, the data comprise a sequence of data blocks BLKᵢ (with i=0, 1, . . . N) (for example, logs, documents, transactions, chats and so on) stored in a first repository means 110_{D} of the ledger 110 (hereinafter simply referred to as data repository 110_{D}), or more thereof, and history information Hⱼ (with j=0, 1, . . . P), defining as a whole a ledger history, stored in a second repository means 110_{H} of the ledger 110 (hereinafter simply referred to as history repository 110_{H}), or more thereof, separate from the data repository 110_{D}.

According to an embodiment, the data repository 110_{D} and the history repository 110_{H} may be physically located or reside in a same storage node 105 (as exemplary illustrated) or in different storage nodes (or in different storage entities other than the storage nodes). By data repository 110_{D} separate from the history repository 110_{H} it is herein meant that the data repository 110_{D} and the history repository 110_{H} may be accessed in an independent way with respect to each other, regardless of their actual physical location (i.e., regardless they are physically located or reside in a same storage node 105, in different storage nodes or in different storage entities).

According to an embodiment, the data blocks BLKᵢ are arranged in the data repository 110_{D} in (chronological) sequence defined by their appending to the ledger 110 (from BLK₀ to BLK_{N} in the example at issue). For this purpose, the data blocks BLKᵢ may only be added in sequence by appending them to an end of the ledger 110. Therefore, the ledger 110 accumulates the data that are never removed from the ledger 110 once they have been added therein (with any updates of the data that preserve all previous versions of the same data).

According to an embodiment, the history information Hⱼ is associated each one with a respective set of one or more adjacent data blocks BLKᵢ of the sequence of data blocks (hereinafter concisely referred to as set of data blocks).

In other words, the history information Hⱼ may comprise history information each one associated with a respective data block BLKᵢ of the sequence of data blocks (e.g., when each set of data blocks includes one data block—hence, P=N), or with a respective plurality of (i.e., two or more) adjacent data blocks BLKᵢ of the sequence of data blocks (e.g., when each set of data blocks includes a plurality of data blocks—hence, P<N). As better discussed in the following, different types of history information Hⱼ may be determined depending on whether the history information Hⱼ is associated each one with a respective data block BLKᵢ or the history information Hⱼ is associated each one with a respective set of adjacent data blocks BLKᵢ of the sequence of data blocks.

According to an embodiment, each set of data blocks may comprise a predetermined number of (adjacent) data blocks BLKᵢ. Just as an example, the predetermined number of adjacent data blocks may depend on specific design options (such as expected frequency of data block appends).

Moving to FIG. 1B, the storage node 105 adds or appends a (new) data block BLKᵢ (for example, the data block BLK_{N+1}) to the ledger 110 (at an end of its sequence).

According to an embodiment, the storage node 105 computes, for the data block BLK_{N+1}, a corresponding block hash BH_{N+1} and a corresponding link hash LH_{N+1}. More generally, going beyond the specific example, the storage node 105 computes, for each i-th data block BLKᵢ, a corresponding block hash BHᵢ and a corresponding link hash LHᵢ.

According to an embodiment, the block hash BH_{N+1} is a hash value of the data block BLK_{N+1}. More generally, going beyond the specific example, each i-th block hash BHᵢ is a hash value of the i-th data block BLKᵢ.

According to an embodiment, the link hash LH_{N+1} is a hash value of the data block BLK_{N+1} based on a combination of the block hash of the data block BLK_{N+1} (i.e., the block hash BH_{N+1}) and of the link hash of the previous adjacent data block BLK_{N} (i.e., the link hash LH_{N}). More generally, going beyond the specific example, each i-th link hash LHᵢ is a hash value of the i-th data block BLKᵢ based on the combination of the block hash of the i-th data block BLKᵢ and of the link hash of the previous, (i−1)-th, adjacent data block (i.e., the link hash LHᵢ₋₁).

Examples of operations that may be used for achieving the combination of the block hash of the data block BLK_{N+1} and of the link hash of the previous adjacent data block BLK_{N} include, but are not limited to, concatenation, addition, subtraction, XOR, and/or fusion operations.

According to an embodiment, the hash value (or digest) is calculated by applying a cryptographic hash function to the content of the ledger 110. The cryptographic hash function is a hash function that maps map data of arbitrary size to hash values of fixed-size. In appending, the cryptographic hash function is deterministic, i.e., it always produces the same hash value for the same input value (with a low risk of collision given by the same hash value for different input values and with an avalanche effect producing extensive changes of the hash value for small changes of the input data); the cryptographic hash function is also non-invertible, i.e., with the hash value that may be calculated from the input data in a relatively fast way but with the input data that is practically infeasible to be calculated from the hash value (because of a computational complexity involving a time complexity longer than a relevance period of the input data, for example, not of polynomial time).

According to an embodiment, the storage node 105 determines the history information associated with the set of data blocks including the data block BLK_{N+1} (i.e., the history information H_{P+1}) based on the link hashes of the data blocks of the set of data blocks. More generally, going beyond the specific example, the storage node 105 determines the history information associated with the set of data blocks including the i-th data block BLKᵢ (i.e., the history information Hⱼ₊₁) based on the link hashes of the data blocks of the set of data blocks.

According to an embodiment, the storage node 105 stores the history information H_{P+1} in the history repository 110_{H}. In general, going beyond the specific example, the storage node 105 stores the history information Hⱼ₊₁ in the history repository 110_{H}.

Separating the data blocks BLKᵢ and the history information Hⱼ from each other allows implementing the data repository 110_{D} by any conventional (e.g., non-DLT) storage entity (such as a conventional database). This allows significantly simplifying data blocks storage/retrieval. Moreover, this allows storing data blocks BLKᵢ of any size (which makes the solution suitable for higher transactional throughput, such as in real-time applications), and allows making history information Hⱼ substantially unaffected by data block size: for example, when the history information Hⱼ comprises the link-hash of each data block of the sequence of data blocks (as better discussed in the following), a size of the ledger history stored in the history repository 110_{H} is linearly dependent only to the number of data blocks of the sequence of data blocks. Therefore, the proposed solution provides adequate support for generic data other than data associated with small financial transactions, and hence it may be applied to a wide variety of data-driven application use cases.

Separating the data blocks BLKᵢ and the history information Hⱼ from each other allows sharing only the data blocks BLKᵢ or only the history information Hⱼ. Thus, for example, there is no need to expose or disclose the data blocks BLKᵢ (which form the content of the ledger) to a certification entity, which instead only needs to receive the history information Hⱼ for certification purposes (e.g., for checking that all the versions of the ledger, up to the current one, are consistent with their preceding versions, such as for auditing purposes). This substantially reduces any overloading of a network used to communicate with the certification entity, with a beneficial effect on performance. Moreover, this substantially avoids disseminating the data blocks BLKᵢ: this is important when access to the data blocks BLKᵢ has to be controlled by restricting it selectively (especially when the data blocks BLKᵢ are subject to strict confidentiality requirements).

The above advantages are achieved in a quite simple way, thereby involving a relatively low consumption of networking, computational and storage resources (especially as compared to the use of a blockchain for storing both the data blocks and the history information).

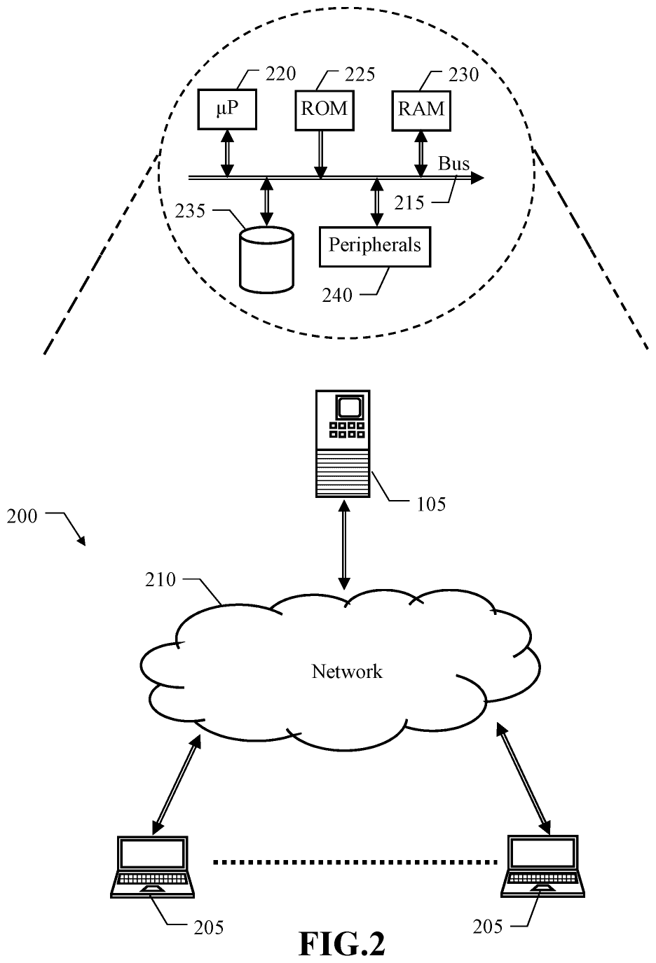

With reference now to FIG. 2, it shows, in terms of operating units, a schematic block diagram of an information technology infrastructure 200 (hereinafter concisely referred to as infrastructure) that may be used to implement the solution according to embodiments of the present disclosure.

According to an embodiment, the infrastructure 200 comprises one or more of the storage nodes 105. In the illustrated example, the infrastructure 200 comprises a plurality (i.e., two or more) of the storage nodes 105.

According to an embodiment, the infrastructure 200 comprises a certification entity 205. According to an embodiment, the certification entity 205 is configured to access the history information stored in the storage nodes 105 for checking a consistency thereof (or, more generally, for checking a consistency of the data stored in the ledger). According to an embodiment, the certification entity 205 comprises a trusted central authority.

According to an embodiment, the infrastructure 200 comprises one or more (e.g., a plurality of) client nodes (hereinafter concisely referred to as clients) 210. According to an embodiment, each client 210 is configured to access the data stored in the storage nodes 105 by (authorized) users thereof. According to an embodiment, each client 210 may be configured to allow checking the consistency of the data stored in the storage nodes 105 (in this embodiment, the certification entity 205 may also be omitted). According to an embodiment, each client 210 may be configured to allow checking the consistency of the data stored in the storage nodes 105 by means of a proper consensus schema. According to an embodiment, the consensus schema may involve one or more clients (e.g., a plurality of clients) of a peer-to-peer network. Just as an example, the consensus schema may comprise proof of work, proof of stake, proof of elapsed time, and Kafka algorithms.

According to an embodiment, the infrastructure 200 comprises a telecommunication network 215. According to an embodiment, the telecommunication network is configured to allow the storage nodes 105, the certification entity 205 (when provided) and the clients 210 to communicate with each other. According to an embodiment, the telecommunication network 215 comprises a global telecommunication network based on the Internet. According to an embodiment, the telecommunication network 215 comprises a wired telecommunication network and/or a wireless communication network.

According to an embodiment, the storage nodes 105, the certification server 205, and the clients 210 identify, each one a respective computing system.

According to an embodiment, each computing system comprises a plurality of devices that are connected to each other through a bus structure 220 at one or more levels (with an architecture that is suitably scaled according to the type of the computing system).

According to an embodiment, each computing system comprises a microprocessor (μP) 225, or more thereof, providing a logic capability of the computing system.

According to an embodiment, each computing system comprises a non-volatile memory (ROM) 230 for storing basic code for a bootstrap of the computing system.

According to an embodiment, each computing system comprises a volatile memory (RAM) 235 used as a working memory by the microprocessor 225.

According to an embodiment, each computing system comprises a mass-memory 240 for storing programs and data. Just as an example, the mass-memory 240 may comprise storage devices of a data center wherein the storage nodes 105 and the certification entity 205 are implemented. Just as another example, the mass-memory 240 may comprise a Solid State Disk (SSD) for each client 210.

According to an embodiment, each computing system comprises a number of controllers for peripherals, or Input/Output (I/O) devices, 245. Just as an example, the peripherals 245 of each storage node 105 and of the certification entity 205 may comprise a network adapter plugging them into the corresponding data center and then connecting them to a console of the data center for their control (for example, a personal computer, also provided with a drive for reading/writing removable storage devices, such as of USB type) and into a switch/router sub-system of the data center for their communication with the telecommunication network 215. Just as another example, the peripherals 245 of each client 210 may comprise a keyboard, a mouse, a monitor, a network adapter for connecting to the telecommunication network 215 and a drive for reading/writing removable storage devices (such as of USB type).

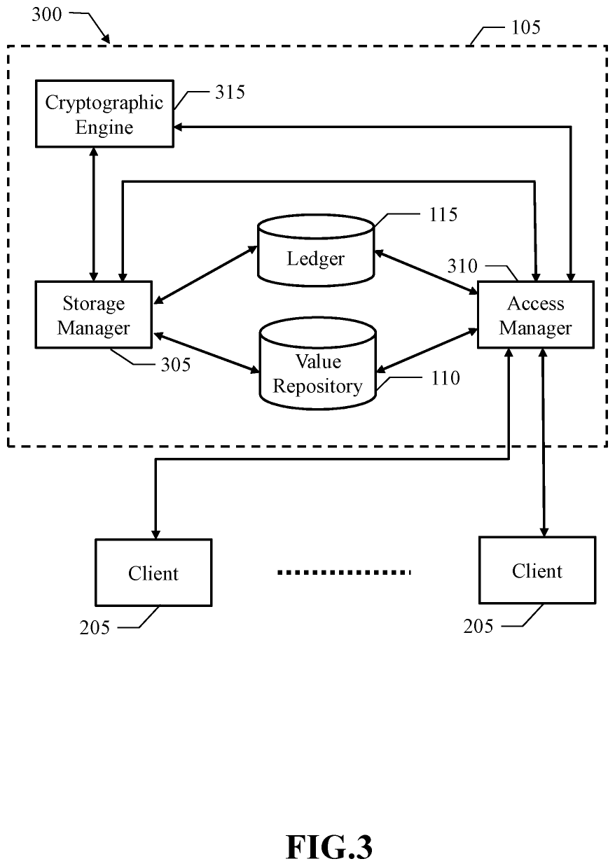

With reference now to FIG. 3, it shows the main software components that may be used to implement the solution according to embodiments of the present disclosure. Particularly, this figure shows the main software components 300 that may be used to implement the generic storage node 105 according to embodiments of the present disclosure. For the sake of completeness, this figure also shows the data repository 110_{D} and the history repository 110_{H}, as well as some computing systems of the infrastructure 200 that may interact (when provided) with the storage node 105 (e.g., other storage nodes 105, the certification entity 205, and the clients 210).

According to an embodiment, the software components 300 are stored in the mass memory and loaded (at least partially) into the working memory of the storage node 105 when the programs are running, e.g. together with an operating system and other application programs not directly relevant to the solution according to embodiments of the present disclosure (thus omitted in the figure for the sake of simplicity). The programs are initially installed into the mass memory, for example, from removable storage devices or from the telecommunication network. In this respect, each program may be a module, segment or portion of code, which comprises one or more executable instructions for implementing the specified logical function.

According to an embodiment, the software components 300 of the storage node 105 comprise a storage manager 305 for managing data storing. According to an embodiment, the storage manager 305 is configured to manage the storing of the sequence of data blocks and of the associated history information in the ledger.

According to an embodiment, the storage manager 305 reads/writes the data repository 110_{D} storing the data blocks, and the history repository 110_{H} storing the history information.

According to an embodiment, the storage manager 305 interacts with the other storage nodes 105.

According to an embodiment, the software components 300 of the storage node 105 comprise an access manager 310. According to an embodiment, the access manager 310 manages the access to the data stored in the storage node 105. According to an embodiment, the access manager 310 selectively reads the data repository 110_{D} and the history repository 110_{H}. According to an embodiment, the access manager 310 downloads information extracted from the ledgers to the (user/auditor) clients 210, and/or to the certification entity 205. Just as an example, the access manager 310 may selectively download the data blocks from the data repository 110_{D} to the (user/auditor) clients 210, and the history information from the history repository 110_{H} to the to the certification entity 205.

According to an embodiment, the software components 300 of the storage node 105 comprise an encapsulation engine 315 implementing encapsulation and/or recursive encapsulation operations. According to an embodiment, the encapsulation engine 315 generates, for each data block, a corresponding encapsulated data block including the data block and respective metadata associated therewith.

According to an embodiment, the encapsulation engine 315 interacts with the storage manager 305 (for example, so as allow data block reception and encapsulated data block transmission).

According to an embodiment, the software components 300 of the storage node 105 comprise a cryptographic engine 320 implementing cryptography operations. According to an embodiment, the cryptographic engine 320 computes, for each data block, the respective block hash and the respective link hash.

According to an embodiment, the cryptographic engine 320 interacts with the storage manager 305 (e.g., so as to allow transmission (to the storage manager 305) of the link hashes to be stored as history information into the history repository 110_{H}).

According to an embodiment, the software components 300 of the storage node 105 comprise a Merkle tree manager 325. According to an embodiment, the Merkle tree manager 325 is configured to compute (i.e., update) and store a Merkle tree root of the ledger. Each inner node of the Merkle tree is associated with the hash values of the concatenation of the hash values of its (two) child nodes, up to the hash value of a root node of the Merkle tree that defines a digest of the ledger. For example, in case of a ledger with 7 data blocks BLK₀-BLK₆ having corresponding has values H₀-H₆, a hash value Hor is calculated by pairing the hash values H₀ and H₁, a hash value H₂₃ is calculated by pairing the hash values H₂ and H₃, a hash value H₄₅ is calculated by pairing the hash values H₄ and H₅, a hash value H₀₃ is calculated by pairing the hash values H₀₁ and H₂₃, a hash value H₄₆ is calculated by pairing the hash values H₄₅ and H₆, and a hash value H₀₆is calculated by pairing the hash values H₀₃ and H₄₆ (the hash value H₀₆ defining a digest of the ledger).

According to an embodiment, the Merkle tree manager 325 arranges the link hashes of the data blocks of the sequence of data blocks into a Merkel tree (or other hierarchical structure).

According to an embodiment, the Merkle tree manager 325 is configured to determine a consistency proof. A consistency proof of a new version of the ledger with respect to a current version of the ledger, provides information that allows verifying that the new version and the current version of the ledger are consistent (without the need of actually knowing them); this means that the new version contains the current version without any alteration and that the new version has been obtained by extending the current version (appending data at the end thereof).

For example, in this case the consistency proof is the Merkel consistency proof. The Merkle consistency proof is defined by the minimum set of hash values in the Merkle tree of the new version of the ledger that are required to verify that the new version contains the current version of the ledger without any alteration and that the new version has been obtained by extending the current version (appending the new data block at the end thereof). In the above-mentioned example, a very simple consistency proof for the appending of a (single) new data block BLK₇ having corresponding hash value H₇ is defined by a list of hash values H₀₃, H₄₅, H₆ for verifying the containment of the current version plus the hash value H₇ for verifying the appending of the new data block. Particularly, by accumulating the list of hash values from right to left into a single hash value, i.e., calculating the hash value H₄₆ by pairing the hash values H₄₅ and H₆, and calculating the hash value H₀₆ by pairing the hash values H₀₃ and H₄₆, and then comparing the hash value H₀₆ with the current digest, it is possible to verify whether the new version contains the (unaltered) current version of the ledger. Moreover, calculating a hash value H₆₇ by pairing the hash values H₆ and H₇, calculating a hash value H₄₇ by pairing the hash values H₄₅ and H₆₇, and calculating a hash value Hoz by pairing the hash values H₀₃ and H₄₇, and then comparing the hash value Hoz with the new digest, it is possible to verify whether the new version has been obtained by extending the current version.

According to an embodiment, the Merkle tree manager 325 interacts with the storage manager 305 (e.g., so as to allow transmission (to the storage manager 305) of the Merkle consistency proofs to be stored as history information into the history repository 110_{H}).

According to an embodiment, the Merkle tree manager 325 interacts with the access manager 310 (e.g., so as to allow selective access to the Merkle tree by the certification entity 205 and/or the clients 210).

According to an embodiment, the Merkle tree manager 325 interacts with the cryptographic engine 320 (e.g., so as to trigger Merkle tree update after link hash computation).

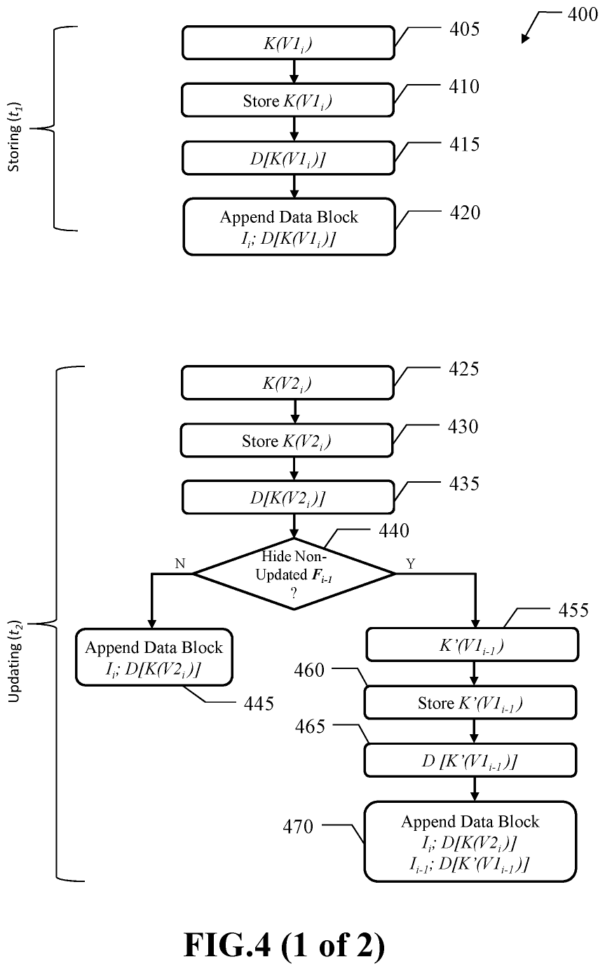

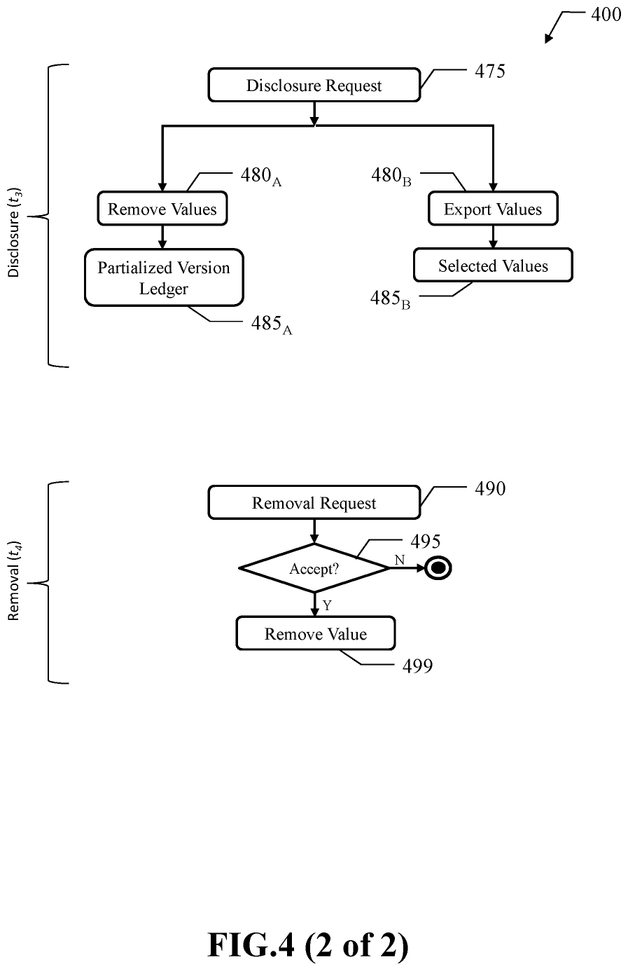

With reference now to FIG. 4, it shows an activity diagram which describes the flow of activities relating to an implementation of the solution according to embodiments of the present disclosure. Particularly, the activity diagram represents an exemplary process or method 400 that may be used to store a sequence of data blocks BLKᵢ and history information Hⱼ associated therewith. More particularly, the activity diagram represents an exemplary (single) iteration of the process or method 400 that may be used to store a single data block of the sequence of data blocks BLKᵢ (in the considered example, the data block BLK_{N+1}) and a single history information of the history information Hⱼ (in the considered example, the history information H_{P+1}). In this respect, each node of the activity diagram may correspond to one or more executable instructions for implementing the specified logical function on the relevant software component of the storage node 105.

According to an embodiment, the sequence of data blocks may comprise one or more application data blocks (i.e., blocks of user-specific data or information generated and managed by an application).

Additionally or alternatively, the sequence of data blocks may comprise one or more structural data blocks (i.e., blocks of structural data or information for ledger management).

According to an embodiment, the method 400 comprises, upon reception of the data block BLK_{N+1} (action node 405), storing the data block BLK_{N+1} (or a processed version thereof, as better discussed here below) in the data repository 110_{D} (action node 415). According to an embodiment, the storing of the data block BLK_{N+1} in the data repository 110_{D} is managed by the storage manager 305 of the storage node 105.

According to an embodiment, reception of the data block BLK_{N+1} may arise in response to a corresponding command (such as an appending command) from a client, from an administrator of the storage node, or from a (local/remote) software application.

According to an embodiment, as mentioned above, the method 400 comprises storing a processed version of the data block BLK_{N+1} in the data repository 110_{D}. According to an embodiment, the processed version of the data block BLK_{N+1} comprises an encapsulated version of the data block BLK_{N+1} (hereinafter, encapsulated data block). According to an embodiment, the encapsulated data block comprises the data block BLK_{N+1} and corresponding metadata associated therewith. For the purposes of the present disclosure, metadata is data providing or summarizing basic information about other data (e.g., the data contained in the data block BLK_{N+1}) without exposing a content thereof.

In this embodiment, the method 400 comprises processing the data block BLK_{N+1} and metadata associated therewith with an encapsulation operation (action node 410), thereby obtaining the corresponding encapsulated data block, and storing the encapsulated data bock in the data repository 110_{D} (action node 415).

According to an embodiment, encapsulation may comprise a recursive encapsulation determining an encapsulated data block with a plurality of (i.e., two or more) encapsulation levels. In this embodiment, each encapsulation level may be associated with respective metadata.

According to an embodiment, the number of encapsulation levels may depend on a data block type (e.g., application data block or structural data block), although this should not be construed limitatively.

According to an embodiment, encapsulation may be performed for the data block BLK_{N+1} and/or for any other data bock of the sequence of data blocks. Therefore, depending on the received data block, encapsulation performed at action node 410 may also be omitted. In any case, encapsulation may be omitted in basic embodiments of the present disclosure.

According to an embodiment, encapsulation is performed by the encapsulation engine 315 of the storage node 105.

Just as an example of a practical use-case scenario, the metadata may comprise a digital signature of the encapsulated data block.

Just as another example of a practical use-case scenario, the metadata may comprise information about a data block encryption (such as a public key in case of asymmetric key encryption, or a key identifier in case of symmetrical key encryption).

Just as another example of a practical use-case scenario, the metadata may comprise a link-hash to a data block referenced by the encapsulated data block. If the data block is chained to a different ledger, the metadata may further contain a ledger identifier identifying it.

Just as another example of a practical use-case scenario, the metadata may comprise the block hash of an off-chain data block, and, optionally, specify an access handle to access it.

Just as another example of a practical use-case scenario, the metadata may comprise an additional public key of an asymmetrical cryptography key pair to be added to an author list of the ledger.

Just as another example of a practical use-case scenario, the metadata may comprise an indication (or acknowledge) of a point of the ledger that the author of the respective data block declares to have received, parsed and validated at ledger policy level.

Just as another example of a practical use-case scenario, the metadata may comprise an indication (or agree) of a point of the ledger that the author of the respective data block declares to have received, parsed and validated at application policy level.

Just as another example of a practical use-case scenario, the metadata may comprise an indication that the ledger should be considered closed, and, optionally, specify a reason for it (including, but not limited to, encryption key being compromised, end of planned life of the ledger, migration to a different ledger).

Just as another example of a practical use-case scenario, the metadata may comprise an indication one or more policies associated with the ledger.

According to an embodiment, the one or more policies associated with the ledger may comprise one or more criteria for data block trustworthiness or constraints. Examples of criteria for data block trustworthiness or constraints comprise, but are not limited to, one or more among provision of an author list (public keys of asymmetric cryptography), conditioning a validity of a data block to a signature by an author of the author list, possibility and constraints to alter the author list, acknowledge and agree protocols for the authors, procedures for managing data blocks that are not following the policies, procedures for referring to (and possibly accessing) off-chain data blocks, and maximum data block size.

According to an embodiment, the one or more policies associated with the ledger may comprise, additionally or alternatively to the previous criteria, one or more criteria related to data block encapsulation. Examples of criteria related to data block encapsulation comprise, but are not limited to, allowed encapsulation stacks and encapsulation level visibility without a decryption key (in which case an encapsulation format may advantageously be modified to allow a plaintext list of encapsulations levels).

According to an embodiment, the one or more policies associated with the ledger may comprise, additionally or alternatively to any of the previous criteria, one or more criteria for policy update. Examples of criteria related to policy update comprise, but are not limited to, possibility, conditions and procedures for policy update.

According to an embodiment, the one or more policies associated with the ledger may comprise, additionally or alternatively to any of the previous criteria, one or more criteria for data block signature and/or encryption. Examples of criteria related to data block signature and/or encryption comprise, but are not limited to, provision of an asymmetric cryptography public key to be used for ledger encryption, provision of signatures and/or encryption algorithms.

The availability of the policies associated with the ledger (i.e., both at ledger level and at application level) allows supporting a wide range of possible use cases, and hence customizing the ledger for specific use cases.

Moreover, the availability of the policies associated with the ledger, together with the possibility of having data blocks of any size, allows implementing a single DLT network-like solution that supports a wide range of data-driven use cases, with interoperability.

According to an embodiment, the method 400 comprises computing the block hash BH_{N+1} of the data block BLK_{N+1} (action node 420). In this embodiment, as conceptually represented in the figure by activity diagram bifurcation after reception of the data block BLK_{N+1} (action node 405), action node 420 (and subsequent nodes) may be performed in an independent (e.g., concurrent) way with respect to action nodes 410 and 415.

According to an alternative embodiment, not shown, the method 400 comprises computing the block hash BH_{N+1} of the encapsulated data block. In this embodiment, action node 420 (and subsequent nodes) may be performed after action node 410 (for example, before or after the action node 415).

According to an alternative embodiment, not shown, block hash computation is performed before encapsulation. This could be the case of, for example, embodiments in which the block hash of a data block is intended to be made available as metadata of that data block (such as the block hash of an off-chain data block).

According to an embodiment, block hash computation is performed by the cryptographic engine 320 of the storage node 105. According to an embodiment, block hash computation is performed in response to a corresponding command from the storage manager 305 of the storage node 105.

According to an embodiment, the method 400 comprises computing the link hash LH_{N+1} of the data block BLK_{N+1} (action node 425).

According to an embodiment, the link hash LH_{N+1} of the data block BLK_{N+1} is based on the combination of the block hash of that data block BLK_{N+1} (i.e., the block hash BH_{N+1}) and of the link hash of the previous adjacent data block BLK_{N} (i.e., the link hash LHN). According to an embodiment, the link hash LH_{N+1} of the data block BLK_{N+1} is based on a concatenation between the block hash of that data block BLK_{N+1} (i.e., the block hash BH_{N+1}) and the link hash of the previous adjacent data block BLK_{N} (i.e., the link hash LH_{N}).

According to an embodiment, link hash computation is performed by the cryptographic engine 320 of the storage node 105. According to an embodiment, link hash computation is performed in response to a corresponding command from the storage manager 305 of the storage node 105.

According to an embodiment, the method 400 comprises updating (or generating, at a first running the method) the Merkle tree of the ledger (action node 430) according to the computed the link hash LH_{N+1}.

According to an embodiment, Merkle tree updating is performed by the Merkle tree manager 325 of the storage node 105, for example in response to a corresponding command from the storage manager 305 and/or of the cryptographic engine 320 after link hash computation.

According to an embodiment, the method 400 comprises determining the history information H_{P+1} associated with the set of data blocks including the data block BLK_{N+1} based on the link hashes of the data blocks of the set of data blocks (action node 440).

According to an embodiment, the history information H_{P+1} comprises the link hash LH_{N+1} of the data block BLK_{N+1}. Therefore, in this embodiment, the set of data blocks comprises a single data block (i.e., P=N), and hence the size of the ledger history stored in the history repository 110_{H} is linearly dependent only to the number of data blocks of the sequence of data blocks.

According to an alternative (herein considered) embodiment, the history information H_{P+1} comprises a consistency proof (e.g., the Merkle consistency proof in the example at issue) determined based on the data blocks (particularly, one or more of the link hashes thereof) of the set of data blocks. Therefore, in this embodiment, the set of data blocks comprises a plurality of data blocks, and the history information H_{P+1} comprises a consistency proof (e.g., the Merkle consistency proof in the example at issue) determined based on the set of data blocks rather than on each single data block of the sequence of data blocks. Otherwise stated, in this embodiment the link hashes of the set of data blocks are grouped together into a Merkle tree providing a compact representation of the ledger history, and the history information to be stored comprises only the Merkle consistency proofs between the considered roots.

According to an embodiment, if the data block BLK_{N+1} is the last data block of the set of data blocks (exit branch Y of decision node 435), the method 400 comprises determining the history information as the consistency proof (e.g., the Merkle consistency proof in the example at issue) computed based on (one or more of the link hashes of) the set of data blocks (action node 440). According to an embodiment, the consistency proof may be determined by the cryptographic engine 320 or by the Merkle tree manager 325 of the storage node 105 (e.g., under the control of the storage manager 305).

According to an embodiment, if the current data block is not the last data block of the set of data blocks (exit branch N of decision node 435), the method 400 returns to action node 405 waiting for reception of a next data block (as conceptually represented in the figure by connection between exit branch N of the decision node 435 and action node 405).

In this embodiment, the size of the ledger history stored in the history repository 110_{H} has a sub-linear dependency from the number of data blocks of the sequence of data blocks (i.e., P<N), hence this embodiment may be advantageous for ledgers where a high or relatively frequency of data block appends is expected.

According to an embodiment, the method 400 comprises storing the history information H_{P+1} associated with the set of data blocks (i.e., the link hash LH_{N+1} of the data block BLK_{N+1} or the consistency proof, as the case may be) in the history repository 110_{H} (action node 445).

According to an embodiment, the method 400 then returns to action node 405 waiting for reception of a next data block.

### Modifications

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may be practiced even without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. Moreover, items presented in a same group and different embodiments, examples or alternatives are not to be construed as de facto equivalent to each other (but they are separate and autonomous entities). In any case, each numerical value should be read as modified according to applicable tolerances; particularly, unless otherwise indicated, the terms “substantially”, “about”, “approximately” and the like should be understood as within 10%, preferably 5% and still more preferably 1%. Moreover, each range of numerical values should be intended as expressly specifying any possible number along the continuum within the range (comprising its end points). Ordinal or other qualifiers are merely used as labels to distinguish elements with the same name but do not by themselves connote any priority, precedence or order. The terms include, comprise, have, contain, involve and the like should be intended with an open, non-exhaustive meaning (i.e., not limited to the recited items), the terms based on, dependent on, according to, function of and the like should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

An aspect of the solution according to embodiments of the present disclosure provides a method for storing data. Without losing generality, the data may be of any type (for example, partial, different and additional data with respect to the ones mentioned above).

According to an embodiment, the method comprises storing a sequence of data blocks in at least one first repository means of a ledger. Without losing generality, the data blocks may comprise any number and type of data blocks. Just as an example, the data blocks of the sequence of data blocks may be arranged in succession via corresponding links (e.g., defined by their digests and/or indexes and/or their position in files and/or databases). Without losing generality, the first repository means may be any conventional (e.g., non-DLT) storage entity, such as a conventional database. Without losing generality, the storing of the sequence of data blocks in the at least one first repository means of the ledger may comprises any additional operation, down to none (for example, verifying a digital signature and/or or an authorization associated with each data block of the sequence of data blocks).

According to an embodiment, the method comprises computing, for each data block of the sequence of data blocks, a block hash being a hash value of said data block. Without losing generality, the block hash may be computed based on any proper cryptographic hash function or any other mathematical algorithm mapping data of an arbitrary size to a bit array of a fixed size.

According to an embodiment, the method comprises computing, for each data block of the sequence of data blocks, a link hash being a hash value based on a combination of the block hash of said data block and of the link hash of a previous data block, in the sequence of data blocks, being adjacent to said data block. Without losing generality, the link hash may be computed based on any proper cryptographic hash function or any other mathematical algorithm mapping data of an arbitrary size to a bit array of a fixed size.

According to an embodiment, the method comprises determining history information associated with each set of one or more adjacent data blocks of said sequence of data blocks based on the link hashes of the data blocks of said set of adjacent data blocks. Without losing generality, each set of one or more adjacent data blocks of said sequence of data blocks may comprise any number of adjacent data blocks. Without losing generality, the number of adjacent data blocks may depend on a type of data blocks (such as application data blocks or structural data blocks). Without losing generality, the number of adjacent data blocks may be a predetermined number of data blocks of the sequence of data blocks.

According to an embodiment, the method comprises storing the history information associated with the sequence of data blocks in a second repository means of the ledger separate from the at least one first repository means (i.e., accessible in an independent way with respect to the first repository means). Without losing generality, the second repository means may be a conventional (e.g., DLT) storage entity. Without losing generality, the first and second repository means may be physically located in a same storage node, in different storage nodes and/or in different storage entities.

Further embodiments provide additional advantageous features, which may however be omitted at all in basic implementations.

According to an embodiment, said storing a sequence of data blocks comprises encapsulating at least one data bock of said sequence of data blocks each one with one or more respective encapsulation levels. Without losing generality, encapsulation may be performed by any proper data bundling method. Without losing generality, the number of encapsulation levels may depend on a data block type (e.g., application data block or structural data block).

According to an embodiment, said encapsulating comprises, for each of the at least one data bock, adding at least one metadata each one associated with a respective encapsulation level. Without losing generality, type and number of metadata may differ among different encapsulation levels. Without losing generality, metadata may include one or more among descriptive metadata (e.g., for discovery and identification), structural metadata (e.g., for describing types, versions, relationships and other characteristics of the respective data blocks), administrative metadata, reference metadata, statistical or process metadata, legal metadata. However, metadata is not strictly bounded to one of the above categories.

According to an embodiment, said storing a sequence of data blocks comprises storing the encapsulated at least one data bock. Without losing generality, the possibility of storing both data blocks and corresponding encapsulated data blocks is not excluded.

According to an embodiment, said metadata comprises an indication of at least one policy associated with the ledger.

According to an embodiment, said at least one policy associated with the ledger comprises at least one among: one or more criteria for data block trustworthiness or constraints; one or more criteria related to data block encapsulation; one or more criteria for policy update, and one or more criteria for data block signature and/or encryption.

According to an embodiment, the history information comprises, for each data block of said sequence of data blocks, the respective link hash. Without losing generality, the history information may comprise, for each data block of said sequence of data blocks, an indication of the respective link hash.

According to an embodiment, the history information comprises a consistency proof of each set of one or more adjacent data blocks of said sequence of data blocks.

According to an embodiment, the consistency proof comprises a Merkle consistency proof. Without losing generality, in embodiments in which one or more hierarchical structures different from Merkle tree are envisaged for organizing the link hashes, the consistency proof may also differ from the Merkle consistency proof.

According to an embodiment, for each data block, the respective link hash comprises a hash value based on a concatenation between the block hash of the data block and the link hash of the previous data block. Without losing generality, for each data block, the respective link hash may comprise a hash value based on any proper combination (other than concatenation) between the block hash of the data block and the link hash of the previous data block. Examples of combinations other than concatenation may comprise, but are not limited to, addition, subtraction, XOR, and/or fusion operations.

Generally, similar considerations apply if the same solution is implemented with equivalent methods (by using similar steps with the same functions of more steps or portions thereof, removing some non-essential steps or adding further optional steps); moreover, the steps may be performed in a different order, concurrently or in an interleaved way (at least in part).

Another aspect of the solution according to embodiments of the present disclosure provides a computer program configured for causing a computing system (such as the storage node) to perform the method of above when the computer program is executed on the computing system.

Another aspect of the solution according to embodiments of the present disclosure provides a computer program product.

According to an embodiment, the computer program product comprises one or more computer readable storage media having program instructions collectively stored on the readable storage media, the program instructions readable by the computing system to cause the computing system to perform the same method.

Generally, each (software) program may be implemented as a stand-alone module, as a plug-in for a pre-existing software program (for example, a storage manager and a storage client, respectively), or even directly in the latter. It would be readily apparent that it is also possible to deploy the same solution as a service that is accessed through a network (such as in the Internet). Similar considerations apply if the program is structured in a different way, or if additional modules or functions are provided; likewise, the memory structures may be of other types, or may be replaced with equivalent entities (not necessarily consisting of physical storage media). The program may take any form suitable to be used by any computing system, thereby configuring the computing system to perform the desired operations; particularly, the program may be in the form of external or resident software, firmware, or microcode (either in object code or in source code), for example, to be compiled or interpreted. Moreover, it is possible to provide the program on any computer readable storage medium. The storage medium is any tangible medium (different from transitory signals per se) that may retain and store instructions for use by the computing system. For example, the storage medium may be of the electronic, magnetic, optical, electromagnetic, infrared, or semiconductor type; examples of such storage medium are fixed disks (where the program may be pre-loaded), removable disks, memory keys (for example, USB), and the like. The program may be downloaded to the computing system from the storage medium or via a network (for example, the Internet, a wide area network and/or a local area network comprising transmission cables, optical fibers, wireless connections, network devices); one or more network adapters in the computing system receive the program from the network and forward it for storage into one or more storage devices of the computing system. In any case, the solution according to embodiments of the present disclosure lends itself to be implemented even with a hardware structure (for example, by electronic circuits integrated on one or more chips of semiconductor material), or with a combination of software and hardware suitably programmed or otherwise configured.

An embodiment provides a computing system (such as a storage node) comprising means configured for performing the steps of the method of above.

According to an embodiment, the computing system (such as the storage node) comprises a circuitry (i.e., any hardware suitably configured, for example, by software) for performing each step of the same method. Without losing generality, the computing system may be of any type (for example, implemented by a physical machine, a virtual machine, a cloud service and so on).

Another aspect of the solution according to embodiments of the present disclosure provides a system for storing data comprising a plurality of said computing systems.

Without losing generality, the system may have a different architecture (for example, based on a global, local or wide area network, exploiting any type of wired and/or wireless connections, such as of metal wire, optical fiber, Wi-fi, mobile telephone or satellite type, and so on). However, its implementation by virtual machines running on a same physical machine is not excluded.

Generally, similar considerations apply if the computing system and the whole system each has a different structure, comprises equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

1. A method comprising:
storing a sequence of data blocks in at least one first repository means of a ledger;
computing, for each data block of the sequence of data blocks, a block hash being a hash value of said data block;
computing, for each data block of the sequence of data blocks, a link hash being a hash value based on a combination of:
(i) the block hash of said data block, and
(ii) the link hash of a previous data block, in the sequence of data blocks, being adjacent to said data block;
determining history information associated with each set of one or more adjacent data blocks of said sequence of data blocks based on the link hashes of the data blocks of said set of adjacent data blocks, and
storing the history information associated with the sequence of data blocks in a second repository means of the ledger separate from the at least one first repository means.

2. The method according to claim 1, wherein said storing a sequence of data blocks comprises:
encapsulating at least one data bock of said sequence of data blocks each one with one or more respective encapsulation levels, said encapsulating comprising, for each of the at least one data bock, adding at least one metadata each one associated with a respective encapsulation level, and
storing the encapsulated at least one data bock.

3. The method according to claim 2, wherein said metadata comprises an indication of at least one policy associated with the ledger.

4. The method according to claim 3, wherein said at least one policy associated with the ledger comprises at least one among:
one or more criteria for data block trustworthiness or constraints;
one or more criteria related to data block encapsulation;
one or more criteria for policy update;
one or more criteria for data block signature and/or encryption.

5. The method according to claim 1, wherein the history information comprises, for each data block of said sequence of data blocks, the respective link hash.

6. The method according to claim 1, the history information comprises a consistency proof of each set of one or more adjacent data blocks of said sequence of data blocks.

7. The method according to claim 6, wherein the consistency proof comprises a Merkle consistency proof.

8. The method according to claim 1, wherein, for each data block, the respective link hash comprises a hash value based on a concatenation between the block hash of the data block and the link hash of the previous data block.

9. (canceled)

10. A software program product comprising one or more computer readable storage media having program instructions collectively stored on the readable storage media, the program instructions being readable by a computing system to cause the computing system to perform the method according to claim 1.

11. A computing system comprising circuitry configured for performing the method according to claim 1.

12. (canceled)
